(19) United States
(12) Patent Application Publication
(10) Pub. No.: US 2025/0292062 A1
(43) Pub. Date: Sep. 18, 2025

(54) Multi-Task Machine Learning Using Coefficient Conditioning

(71) Applicant: International Business Machines Corporation, Armonk, NY (US)

(72) Inventors: Hiroshi Kajino, Tokyo (JP); KOHEI MIYAGUCHI, Tokyo (JP); Kento Nozawa, Kashiwa (JP)

(21) Appl. No.: 18/602,499

(22) Filed: Mar. 12, 2024

(51) Int. Cl. G06N 3/045; G06N 3/0985

(52) U.S. Cl. CPC G06N 3/045; G06N 3/0985

(57) ABSTRACT

Mechanisms are provided for reconfiguring a pre-trained ML model. Weight vectors are sampled from a pre-defined distribution to produce sampled weight vectors. A conditioning module is trained by minimizing a multi-task training loss over the sampled weight vectors, the multi-task training loss being a combination of task loss functions resulting from multiple tasks, respectively, each of the task loss functions being calculated by using a corresponding training dataset and a corresponding element of the respective sampled weight vector. The conditioning module includes computer executable logic implementing a function from the sampled weight vectors to a parameter space of a pre-trained machine learning model, the elements of the weight vector specifying a relative importance of a corresponding task. An operational parameter for the pre-trained machine learning model is determined by using the trained conditioning module, and the pre-trained machine learning model is reconfigured with the determined operational parameter.

### BACKGROUND

The present application relates generally to data processing, computing tool operations/functionality, and multi-task machine learning.

Multi-task learning (MTL) is a subfield of machine learning in which multiple learning tasks are solved at the same time while exploiting commonalities and differences across the tasks. This can result in improved learning efficiency and prediction accuracy for the task-specific models when compared to training the models separately. In the classification context, for example, MTL aims to improve the performance of multiple classification tasks by learning them jointly. Multi-task learning combines learning signals from multiple tasks into a single model, which is affected by how well different tasks agree with each other or contradict each other.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for reconfiguring a pre-trained ML model. The method comprises sampling weight vectors from a pre-defined distribution to produce sampled weight vectors and training a conditioning module by minimizing a multi-task training loss over the sampled weight vectors, the multi-task training loss being a combination of task loss functions resulting from multiple tasks, respectively, each of the task loss functions being calculated by using a corresponding training data set and a corresponding element of the respective sampled weight vector. The conditioning module comprises computer executable logic implementing a function from the sampled weight vectors to a parameter space of a pre-trained machine learning model, the elements of the weight vector specifying a relative importance of a corresponding task of the multiple tasks. The method further comprises determining an operational parameter for the pre-trained machine learning model by using the trained conditioning module, and reconfiguring the pre-trained machine learning model with the determined operational parameter.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example diagram illustrating an operation of the primary components of a coefficient conditioning module (CMM) that acts as a machine learning training engine in accordance with one illustrative embodiment;

FIG. 3 is an example diagram illustrating a trade-off relationship between loss functions of a multi-task machine learning computer model; and

FIG. 4 is a flowchart outlining example operations of elements of the present invention with regard to one or more illustrative embodiments.

### DETAILED DESCRIPTION

The illustrative embodiments provide an improved computing tool and improved computing tool operations/functionality for multi-task machine learning. More specifically, the illustrative embodiments provide an improved computing tool and improved computing tool operations/functionality that provides conditioning modules that generate a Pareto-front approximation for multi-task machine learning.

The following description provides examples of embodiments of the present disclosure, and variations and substitutions may be made in other embodiments. Several examples will now be provided to further clarify various aspects of the present disclosure.

Example 1: A computer-implemented method comprising sampling weight vectors from a pre-defined distribution to produce sampled weight vectors and training a conditioning module by minimizing a multi-task training loss over the sampled weight vectors, the multi-task training loss being a combination of task loss functions resulting from multiple tasks, respectively, each of the task loss functions being calculated by using a corresponding training data set and a corresponding element of the respective sampled weight vector. The conditioning module comprises computer executable logic implementing a function from the sampled weight vectors to a parameter space of a pre-trained machine learning model, the elements of the weight vector specifying a relative importance of a corresponding task of the multiple tasks. The computer-implemented method further comprises determining an operational parameter for the pre-trained machine learning model by using the trained conditioning module, and reconfiguring the pre-trained machine learning model with the determined operational parameter.

The above limitations advantageously enable the reconfiguring of a pre-trained ML model for one or more tasks without having to retrain all of the parameters of the pre-trained ML model. To the contrary, an operational parameter for the pre-trained ML model may be determined based on the training of the condition module without having to re-train the parameters of the pre-trained ML model. This greatly reduces the costs for adapting pre-trained ML models to tasks both with regard to time and resources.

Example 2: The limitations of any of Examples 1 and 3-12, where the reconfiguring comprises adding the determined operational parameter to a layer of the pre-trained machine learning model. The above limitations advantageously provide a mechanism by which operational parameters of individual layers of the pre-trained ML model may be determined without re-training all of the parameters of the pre-trained ML model.

Example 3: The limitations of any of Examples 1-2 and 4-12, where the conditioning module implements a product of low-rank matrices according to a Low-Rank Adaptation (LoRA) technique. The above limitations advantageously provide a mechanism for fine tuning a machine learning model with reduced resource consumption and faster iterations of machine learning.

Example 4: The limitations of any of Examples 1-3 and 5-12, where the determining of the operational parameter and the reconfiguring of the pre-trained machine learning model are performed iteratively over varied selected weight vectors to produce respective graph points, and where the respective graph points are added to a graph to produce an approximated Pareto-front. The above limitations advantageously provide a mechanism by which an iterative building of a graph which can be used to evaluate tradeoffs or balance between performance of the pre-trained ML model for various tasks when determining the operational parameter for the pre-trained ML model.

Example 5: The limitations of any of Examples 1-4 and 6-12, further including inputting a hyperparameter to the approximated Pareto-front to receive a corresponding additive parameter for fine-tuning the pre-trained machine learning model. The above limitations advantageously provide a mechanism to fine-tune the per-trained ML model without having to retrain the pre-trained model and instead utilize an additive parameter to perform the fine-tuning. This is further based on the balance of multi-task performance represented by the approximate Pareto-front and the particular input hyperparameter.

Example 6: The limitations of any of Examples 1-5 and 7-12, where the pre-defined distribution from which the weight vectors are sampled is a uniform distribution of weight vectors. The above limitations advantageously provide for a more uniform sampling of weight vectors for simulating the operation of the pre-trained ML model and determination of operational parameters based on such simulation.

Example 7: The limitations of any of Examples 1-6 and 8-12, where the conditioning module comprises a second machine learning model that is smaller than the pre-trained machine learning model. The above limitations allow for the machine learning training of the second machine learning model for fine tuning at least a subset of the pre-trained ML model operational parameters.

Example 8: The limitations of any of Examples 1-7 and 9-12, where the second machine learning model comprises a hypernetwork. The above limitations again, advantageously allow for the relatively smaller hypernetwork to determine the operational parameters for the relatively larger pre-trained ML model without having to retrain the entire pre-trained ML model.

Example 9: The limitations of any of Examples 1-8 and 10-12, where the method is performed for multiple conditioning modules, and where each reconfiguring is performed via adding the determined operational parameters to a respective different layer of the pre-trained machine learning model. The above limitations advantageously allow for the fine tuning of operational parameters of individual layers, corresponding to the individual conditioning modules, of the pre-trained ML model for specific tasks without having to retrain the entire pre-trained ML model.

Example 10: The limitations of any of Examples 1-9 and 11-12, further including performing initial multi-task pre-training on the pre-trained machine learning model so that an initial set of weights is produced, where the initial set of weights is provided for the training of the conditioning module. The above limitations advantageously provide a basis from which the conditioning module may be trained and to which the additive parameters may be added to reconfigure the pre-trained machine learning model.

Example 11: The limitations of any of Examples 1-10 and 12, where an approximated Pareto-front is produced and the performing the initial multi-task pre-training occurs only once. The above limitations advantageously provide a reduction in consumption of resources when fine tuning a pre-trained machine learning model for one or more specific tasks by only requiring the full multi-task pretraining once with subsequent reconfiguring providing the operational parameters for fine-tuning the multi-task pretrained machine learning model for one or more specific tasks.

Example 12: The limitations of any of Examples 1-11, where the pre-trained machine learning model is one of a foundation model or a large language model that is pre-trained on first sets of data, and where the reconfiguring prepares the pre-trained machine learning model for a specific task or set of specific tasks. The above limitations advantageously allow for the reconfiguring of large scale computer models that are already trained on general domain data such that their performance is improved with regard to individual tasks by determining the operational parameters for the pre-trained ML model that improve its performance for that particular task or set of tasks.

Example 13: A system comprising one or more processors and one or more computer-readable storage media collectively storing program instructions which, when executed by the one or more processors, are configured to cause the one or more processors to perform a method according to any one of Examples 1-12. The above limitations advantageously enable a system comprising one or more processors to perform and realize the advantages described with respect to Examples 1-12.

Example 14: A computer program product comprising one or more computer readable storage media, and program instructions collectively stored on the one or more computer readable storage media, the program instructions comprising instructions configured to cause one or more processors to perform a method according to any one of Examples 1-12. The above limitations advantageously enable a computer program product having program instructions configured to cause one or more processors to perform and realize the advantages described with respect to Examples 1-12.

Multi-task learning (MTL) aims to make a machine learning model generalize well by solving multiple machine learning tasks simultaneously, such as translating from English-to-French and from English-to-Japanese. MLT minimizes a linear combination of multiple loss functions rather than optimize the loss functions individually. By doing so, the final performance of the tasks obtained by the system shows a trade-off relationship between achieving the best performance for all of the tasks. An optimal solution often includes a compromise between effects on the different tasks. Typically, there must be compromise in performance of some tasks in exchange for the others.

It is beneficial to know what this trade-off is as quickly and efficiently as possible for fast decision making. One approach may be to train the MTL system with every combination of coefficient terms individually. However, such a method for determining the coefficients, taking into account a trade-off relationship between coefficients, requires multiple machine learning training operations, one for each possible combination of coefficient terms, which is time consuming, especially with large machine learning systems.

The illustrative embodiments add a parametric coefficient conditioning module to a single MTL system that interpolates a Pareto-front and obtains Pareto efficient models with a single machine learning training operation rather than having to train a MTL system multiple times with every combination of coefficient terms individually. In multi-objective optimization, the Pareto-front (also called Pareto-frontier or Pareto curve) is the set of all Pareto efficient solutions. That is, the Pareto-front is the set of all solutions in a multiple-objective search space, for which there is no way to improve performance in any objective without simultaneously decreasing performance in one or more other objectives. It allows one to restrict attention to the set of efficient choices, and to make tradeoffs within this set, rather than considering the full range of every parameter.

Generating the entire Pareto-front is often computationally-hard. Thus, the added coefficient conditioning module utilizes an approximate Pareto-front. That is, given a pre-trained machine learning computer model, the added coefficient conditioning module generates a subset of weights of the MTL system based on a conditioning of the coefficient terms of the MTL's loss functions. The added coefficient conditioning module is trained by minimizing the expected loss functions for the tasks in the multi-task learning over different coefficient terms to handle any linear combination of the multiple loss functions. The added coefficient conditioning module provides an efficient solution in that the added coefficient conditioning module (CCM) approximates the Pareto-front by only generating and updated a subset of parameters of the pre-trained machine learning computer model conditioned on loss related values, rather than generating all parameters in the machine learning computer model or training the machine learning computer model from scratch. The added CCM performs a lightweight training operation on a pre-trained model and thus, can reduce the number of newly added parameters evaluated by the CCM to a subset of parameters, rather than all the parameters of the machine learning computer model, as the pretrained machine learning computer model has in at least some embodiments already been trained to perform well on at least one downstream task, i.e., the at least one downstream task for which the pretrained machine learning computer model was originally trained.

With the mechanisms of the illustrative embodiments, given pre-trained weights of a machine learning computer model, e.g., a neural network (NN) computer model, deep neural network computer model (DNN), large language model (LLM), foundation model, or the like, the CCM generates a sub-set of the weights conditioned on the loss-dependent hyperparameters λ. A loss-dependent hyperparameter λ is a real-valued vector used to decide the balance of multi-task learning losses. To evaluate different balancing of λ, the CCM minimizes the expected weighted loss of multi-task losses over λ with samples from a predefined distribution, such as a uniform distribution. The illustrative embodiments reduce the computational cost to determine a Pareto-front with only a single machine learning training of the machine learning computer model. After this single training of the machine learning computer model, a point on the Pareto-front may be specified in order to obtain the operational parameters of the model for a given set of hyperparameters and thereby configure the machine learning computer model for a desired balance. Thus, the illustrative embodiments provide an improved computing tool and improved computing tool operations/functionality to generate an approximated Pareto-front and the configuring of a corresponding machine learning model for a desired point along the Pareto-front based on the corresponding hyperparameter balance across the various tasks in the multi-task learning.

With the improved computing tool and improved computing tool operations/functionality of the illustrative embodiments, based on a selection of hyperparameters λ for a machine learning computer model, the mechanisms of the illustrative embodiments are able to identify fine tuning additive parameters automatically for any of the specific tasks, or combination of tasks, in a multi-task learning environment. For example, having generated the approximated Pareto-front, a point along the Pareto-front may be selected for a particular task, or set of tasks in a multi-task environment, and the corresponding additive parameters that provide the best balance for the task(s) may be selected without having to perform any additional training of the machine learning computer model. For example, consider an example scenario in which one wants the machine learning computer model to be configured for translation of English to French and English to Japanese for a news website written in English. For the English to French specific scenario, where English or French speaking countries only access the website, and given a set of hyperparameters λ for English to French translation, the best additive parameters for achieving a desired balance may be automatically selected from the generated Pareto-front and used to dynamically configure an instance of the machine learning computer model. If the website is to be available around the world, and thus both translations are needed, a corresponding point on the Pareto-front that provides a best balance between the various tasks and the corresponding additive parameters for that point are used to configure an instance of the machine learning computer model.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a coefficient conditioning module (CCM) to machine learning training logic that operates to train one or more machine learning computer models. The improved computing tool implements mechanism and functionality, such as the CCM, which cannot be practically performed by human beings either outside of, or with the assistance of, a technical environment, such as a mental process or the like. The improved computing tool provides a practical application of the methodology at least in that the improved computing tool is able to automatically determine an approximate Pareto-front for multi-task learning (MTL) of a machine learning computer model, e.g., neural network, or the like, without having to evaluate all the parameters of the machine learning computer model and without having to perform multiple iterations of machine learning operations for a plurality of different combinations of parameters and loss function coefficient settings.

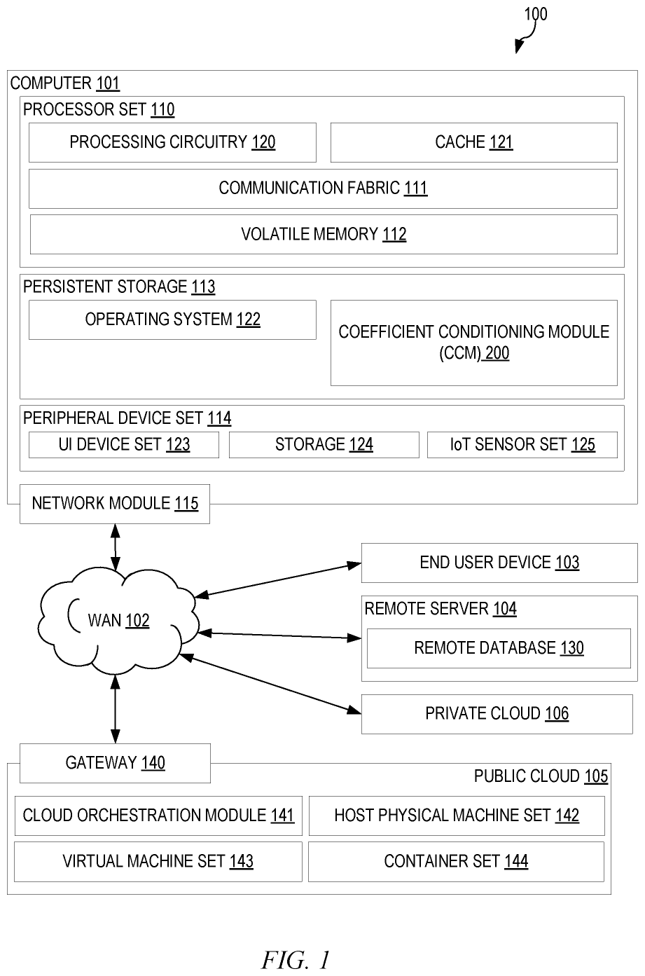

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as coefficient conditioning module (CCM) 200. In addition to CCM 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and CCM 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in CCM 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in CCM 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a CCM 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates determining operational parameters of a multi-task machine learning pre-trained machine learning (ML) computer model (hereafter referred to as the ML model) that provides the optimized trade-off of the loss functions for the various tasks of the ML model.

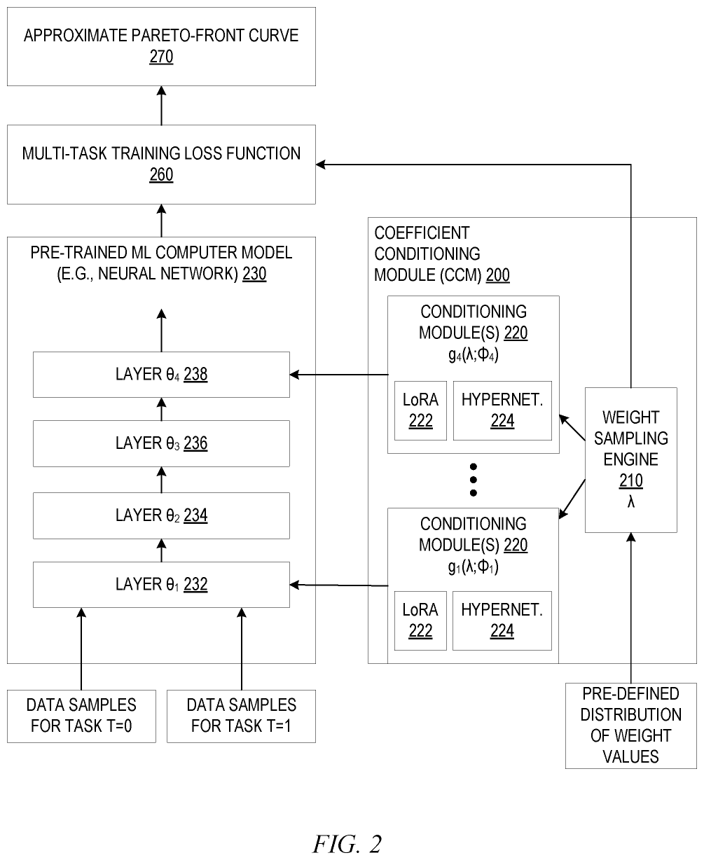

FIG. 2 is an example diagram illustrating an operation of the primary components of a coefficient conditioning module (CMM) that acts as a machine learning training engine in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that that operational parameters, e.g., weights of nodes, in a pre-trained machine learning computer model are optimized for multi-task learning (MTL), and provides a specific coefficient conditioning module (CCM) that takes an arbitrary set of weights of the MTL computer model and determines optimal parameters for each of the weight configurations to thereby approximate a Pareto-front, which cannot be practically performed by human beings as a mental process and is not directed to organizing any human activity. In at least some embodiments the terminology of “weight configuration” means a concrete loss coefficient weight vector λ.

As shown in FIG. 2, the CCM 200 includes a weight sampling engine 210 and one or more conditioning modules 220 for the various layers 232-238 of a pre-trained machine learning (ML) model 230, which is a computer model and in this example is a pretrained neural network 230. The CCM 200 operates to learn a Pareto-front for operational parameters of nodes/layers 232-238 of the pretrained ML model 230 for each weight configuration. The CCM 200 implements one or more shallow neural networks, e.g., the hypernetwork(s) 224, that takes the hyperparameters λ as input and outputs additive parameters, such as additive parameters of a fine tuning model, e.g., the LoRA model architecture 222, for a corresponding layer in the pre-trained ML model 230 to condition the pre-trained ML model 230 without changing/updating its operational parameters θ directly. A shallow neural network is a neural network with a single hidden layer. By using just a single hidden layer, shallow neural networks are more easily trained and have greater computational efficiency than deep neural networks have. In at least some embodiments, the CCM 200 implements a second machine learning model which is smaller than the pre-trained ML model 230, e.g., the hypernetwork 224 is an example of this second machine learning model. The second machine learning model is smaller than the pre-trained ML model 230 with respect to one or more of number of layers and number of parameters used in the layers. By using the second machine learning model that is smaller than the pre-trained ML model 230, a savings in computing power are achieved to produce the operational parameters and the pareto-Front.

It should be appreciated that the pre-trained ML model has a large number of parameters and it is not desirable to have to learn all of these parameters for the multi-task learning. Thus, the illustrative embodiments do not update the pre-trained ML model's parameters θ, but rather fix them during the machine learning training. Instead, a hypernetwork 224 g is learned whose parameters are ϕ. Each hypernetwork 224 outputs additive parameters for θ depending on the hyperparameters λ. The additive parameters are added to their corresponding θ. In at least some embodiments the corresponding θ is for a corresponding layer of the pre-trained ML model 230. The additive parameters are learned by the conditioning modules 220 of the CCM 200 which, in some illustrative embodiments, use the Low-Rank Adaptation (LoRA) architecture and techniques, where the hypernetwork(s) 224 internally output two small matrices (A and B) and compute the matrix product.

In some illustrative embodiments, the one or more conditioning modules 220 of the CCM 200 implement a Low-Rank Adaptation (LoRA) model architecture 222 with a hypernetwork 224. Depending on the desired implementation, there may be different conditioning modules 220 for different layers 232-238 of the pre-trained neural network 230 or the same conditioning module 220 may operate for all of the layers 232-238. Moreover, in some illustrative embodiments, not every layer 232-238 will have its weights determined by a corresponding conditioning module 220 and the original weights from the training of the pre-trained neural network 230 may be maintained for those layers.

The LoRA model architecture 222 implements a technique for fine tuning large scale pre-trained models. That is, these large scale pretrained models are trained on general domain data, for general applicability. A large amount of data is used for their training operation. However, such large scale pretrained models operate poorly for specific tasks due to their generalized training. The LoRA model architecture 222 provides a technique for fine tuning such large scale pre-trained models for a specific task. In the depicted example, the pre-trained neural network 230 may be considered the large scale pretrained model for LoRa model architecture 222 fine tuning operations.

The hypernetwork 224 is a relatively smaller neural network model that generates the weights of a larger model, e.g., the pre-trained neural network model 230. The pre-trained neural network model 230 learns the mappings between raw inputs to desired outputs through a pre-training of the neural network model 230 using machine learning operations. The hypernetwork 224 is supplementary to the pre-trained neural network model 230. The hypernetwork 224 takes a set of inputs that contain information about the structure of the weights, such as layer dimensions, architecture details, or other hyperparameters and determines the weights for a specific layer in the pre-trained neural network model 230, i.e., the additive parameters. In the illustrative embodiments, the hypernetwork 224, i.e., g(λ; ϕ), takes a λ vector as input and generates a weight matrix using, for example, a LoRA parameterization.

LoRA architecture and techniques are designed for parameter-efficient fine-tuning of a single downstream task and cannot be used on their own for learning additive parameters for multi-task environments. The illustrative embodiments combine the second machine learning model, e.g., the hypernetwork 224, with the LoRA architecture 222 of the conditioning module 220 and configure these elements specifically for approximating a Pareto-front curve. It should be appreciated that while the illustrative embodiments are described with reference to a LoRA architecture 222 and techniques for generating additive parameters to be added to the existing parameters in a pre-trained machine learning model, the illustrative embodiments are not limited to such. Other approaches may include the introducing of a new layer between neural networks, e.g., before a first layer of the pre-trained machine learning computer model or after the last layer, and the generating of additive parameters and using those additive parameters for the new layer.

In order to understand the operation of the CCM 200, it is beneficial to first have an understanding of a multi-task learning (MTL) operation and Pareto-front for model loss. As mentioned previously, MTL aims to make a machine learning model generalize well by solving multiple machine learning tasks simultaneously. For example, assume that there are T tasks, a MTL process trains a model f_{θ} with parameter θ using primarily a 3 step process. In a first step, a weight vector λ is fixed as λ=(λ₁, . . . , λ_{T}) where λₜ, is the relative importance of task t. In a second step, each task t's loss function Lₜ(t=1, . . . ,T) is combined into one loss function L_{λ} by taking a weighted average of each task's loss Lₜ. Then, in a third step, the combined loss L_{λ} function is minimized with respect to the parameter θ to obtain the minimizer θ*(λ).

In practice, the weight vector λ must be tuned carefully manually through a trial and error process. However, even in such a case, the best performance cannot be achieved for all the tasks, i.e., there is a tradeoff between tasks for which a compromise must be achieved. This trade-off can be represented as a Pareto-front.

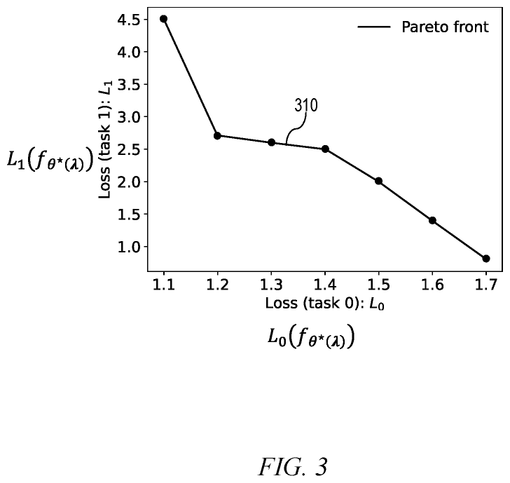

FIG. 3 is an example diagram illustrating a trade-off relationship between loss functions of a multi-task machine learning computer model. As shown in FIG. 3, on the horizontal axis, the loss function L₀ for task 0 is represented, whereas the vertical axis shows the loss function L₁ for task 1. The Pareto-front is shown as the line 310. This Pareto-front represents the compromise in that along this line or curve, any change to the one loss for one task will cause a decrease in performance of the other task. While FIG. 3 shows a relatively simple example involving only two tasks, for purposes of ease of illustration, it can be appreciated that the identification of this Pareto-front becomes quickly impractical for manual determination as the number of tasks increases beyond just two tasks. Even at three or four tasks, the determination of the optimal trade-off compromise becomes too complex to be performed manually or mentally by a human being such that it is impractical to do so. Moreover, this is just for one possible fixed weight vector. This process becomes even more impractical for manual and/or mental performance when one considers a plurality of different weight vectors with a plurality of different tasks of a MTL training of the ML model. Moreover, machine learning models, such as neural networks, often have more than a million parameters affecting the determination of a Pareto-front. If the number of tasks or possible hyperparameter (lambda 2) values increases, this makes it more difficult to determine the Pareto-front approximation such that it is not possible to do so with any expectation of success through manual or mental approaches.

In the above process, one of the major challenges is to determine the appropriate hyperparameter, or weight, vector λ to which the weights are to be fixed to determine the trade-off compromise. Since there is no single criterion to decide the weight vector λ for all the tasks T, a trial and error process may be performed to determine the weight vector λ. That is, a weight vector Δ may be selected, which may be based on a refinement of a previous selection of the weight vector, and the parameter θ is learned by minimizing La to obtain θ*(λ). That is, the value of the parameter θ is learned through an iterative machine learning process, such as linear regression or the like, that modifies the value of the parameter to attempt to minimize the loss value. In this way, the value of the parameter that achieves the minimal loss is identified. The quality of the performance of the ML model (represented as f_{θ*(λ)}) is evaluated quantitatively and qualitatively for all tasks.

For example, to evaluate the approximation quality of the Pareto-front curve that is generated using the conditioning module described herein, another Pareto-front curve is generated by learning a LoRA-based MTL without the CCM 200 for possible λ vectors individually. After this, for the comparison a distance between points on the approximated Pareto-front curve and points obtained individually are measured. The smaller the distance indicates a better approximation of the Pareto-front curve. Moreover, in another evaluation computational time to obtain N points to generate the Pareto-front curve is measured, where a smaller computational time means a better approximation of the Pareto-front curve.

Th manual generation of a full Pareto-front curve is a time and resource intensive process that requires running the machine learning training algorithm a large number of times. This is an especially time-consuming and resource-consuming process with large scale machine learning computer models, such as foundation models, large language models, or even with systems employing multiple machine learning computer models, such as ensemble models and the like. It can be appreciated that this process is also very time consuming and resource consuming when one considers that the process may be performed for multiple different computer model parameter values θ={θ₁, θ₂, θ₃, θ₄, etc.}.

The CCM 200 of the illustrative embodiments simulates the performance of the ML model (f_{θ*(λ)}) for all weight vectors λ with only a single execution of the machine learning training algorithm for the multi-task machine learning training. It should be appreciated that the pre-training of the ML model has already been done, e.g., the pre-trained ML model may be a publicly available ML model that is provided already generally trained, such as in the case of a LLM or foundation model. Thus, the machine learning training algorithm referenced here is for the fine-tuned retraining of the pre-trained ML model for the multi-task learning. This simulation of the performance of the ML model effectively allows the CCM 200 to skip the second step of the process, i.e., learning the parameter θ by minimizing La to obtain θ*(λ). For example, using a simplified MTL operation involving only two tasks, i.e., T=2, if one wants to examine the quality of ML model outputs for three choices of weight vector λ, i.e., λ₁=[0, 1], λ₂=[0.5, 0.5], and λ₃=[1, 0], a naïve approach would require minimizing three loss functions L_{λ}_{₁}, L_{λ}_{₂}, and L_{λ}_{₃} to obtain f_{θ*(λ}_{₁}₎, f_{θ*(λ}_{₂}₎, and f_{θ*(λ}_{₃}₎. The naïve approach requires the execution of the machine learning training algorithm at least three times for each of the possible weight vectors in order to obtain the ML model performance results.

The CCM 200 of the illustrative embodiments, on the other hand, implements a novel loss function L̅ resulting in f_{θ̅*(λ)} such that f_{θ̅*(λ)}≈f_{θ*(λ)} for all weight vectors λ. The left hand side of this relationship is obtained by minimizing the loss function L̅ which simulates the right hand side of this relationship. Thus, the CCM 200 can simulate f_{θ̅*(λ}_{₁₎}, f_{θ̅*(λ}_{₂₎}, and f_{θ̅*(λ}_{₃₎} without having to execute the machine learning training algorithm multiple times.

With the CCM 200, an initial set of weights {λₙ}ₙ₌₁^{N} are provided as hyperparameter inputs to the CCM 200, where N is the number of unique λ vectors and is determined based on a computational budget and a number of tasks for the multi-task learning. For example, weight sampling engine 210 may be given a number of unique weight vectors N to evaluate, and may operate to sample the weight vectors N to generate a subset of weight vectors to evaluate. The subset of sampled weight vectors are provided to the one or more conditioning modules 220 which then conditions one or more operational parameters θ for the corresponding layer(s) 232-238 based on the particular values of λₜ. The one or more conditioning modules 220 are trained by minimizing the expected loss functions of the various tasks T over different coefficient terms to deal with any linear combination of multiple loss functions.

To make weights fixed and the pre-trained ML model 230 (f_{θ}) work with any weight vector λ, some of the pre-trained parameters θ of the pre-trained ML model 230 are conditioned by the one or more conditioning modules 220 on λ=(λₜ, . . . , λ_{T}) using a parameter-efficient architecture, such as the LoRA architecture mentioned above. For example, if the LoRA architecture is utilized, the parameter will be defined as:

$${\overline{θ}}_{l} ( λ ; ϕ ) := {θ}_{l} + {g}_{l} ( λ ; ϕ ) \qquad ( 1 )$$

where l is a layer index in [1, . . . ,L], θₗ is a lth layer's parameter in the pre-trained ML model 230, and gₗ(λ; ϕ) is a conditioning module represented by a product of low-rank matrices, parameterized by ϕ. With respect to the θₗ (lth layer's parameter in the pre-trained ML model 230), the conditioning module provides output into the parameter space of the pre-trained ML model 230 by generating a vector whose dimensionality matches the dimensionality of the vector space of the pre-trained ML model 230. For example, if the weight parameter is a vector whose dimensionality is ten or is a matrix, the conditioning module gₗ(λ; ϕ) generates a vector whose dimensionality is ten or is a matrix, respectively. Thus, the present embodiments include a step of determining parameter space information of the pre-trained ML model 230 in order to appropriately build the conditioning module 220 to match that parameter space. In some embodiments, when a pre-trained ML model is obtained from an available database, information about the parameter space of the pre-trained ML model is provided at that database and is retrieved along with the retrieval/accessing of the pre-trained ML model. In some embodiments, a user helps control generation of the pre-trained ML model and self-selects the parameter space of the pre-trained ML model and thereby knows that information for building the conditioning module 220. This conditioning with equation (1) can condition θₗ to λ via a conditioning module 220 without learning θₗ directly. The CMM 200 learns the parameters of the hypernetwork 224 g: ϕ by minimizing 260. That is, the CMM 200 learns ϕ* such that:

$${\overline{θ}}_{l} ( λ ; {ϕ}^{*} ) \approx {θ}_{l}^{*} ( λ ) \qquad ( 2 )$$

for all λ to obtain a proxy of individually learned results (the right hand side) with a single network.

To learn such ϕ*, a multi-task training loss function 260 is defined as follows:

$$\overline{L} ( ϕ ) = {𝔼}_{λ} [ {\sum }_{t = 1}^{T} {λ}_{t} {L}_{t} ( {f}_{\overline{θ} ( λ ; ϕ )} ) ] \qquad ( 3 )$$

where [symbol] is an operation to take expectation over the probability distribution, such as Dirichlet distribution or the like, and λ is sampled from a pre-defined distribution, such as a uniform distribution or the like. After optimizing this training loss, the parameters θ*ₗ(λ) may be simulated by the conditioning module 220, such as by using Eq. (1) above, with any λ and evaluate Lₜ(f_{θ*(λ)}) without having to execute additional machine learning training operations on the pretrained neural network 230. An approximated Pareto-front 270 is built in some embodiments using the evaluation, and the multi-task learning may be simulated with different λ vectors based on the approximated Pareto-front 270. The conditioning module(s) 220 simulate the corresponding parameters from a λ vector by minimizing the loss in Eq. (3).

Thus, the CCM 200 is enabled to approximate the Pareto-front 270 representing the optimal tradeoff between losses of the various tasks and the corresponding optimal parameters for the pre-trained neural network 230 for the MTL operation. Thus, for each weight configuration, the CCM 200 can determine the optimal parameters for the pre-trained neural network 230. That is, the CCM 200 can determine very quickly which λ values and additive parameters can be used to configure an instance of the pre-trained machine learning computer model that is fine tuned for a particular task or set of tasks without having to perform additional machine learning training of the computer model.

During a preparation phase of operation which in some embodiments is performed only once while still resulting in the parameter determination and/or Pareto-front approximation, a multi-task dataset is prepared and/or obtained and the pre-trained ML model 230 and a predefined distribution of weight values are obtained by using the multi-task dataset. Initial sets of weights obtained via this preparation phase are provided to the conditioning module for assisting with training of the conditioning module. An optimization phase of operation is then executed which is repeated until a convergence criteria is reached, e.g., loss less than a predetermined threshold, or a predetermined number of iterations of machine learning are performed. During the optimization phase of operation, a sampling of λ is performed by the weight sampling engine 210 and a new weight is generated via the hypernetwork 224 of the conditioning module(s) 220 based on this sampled λ, such as by using the LoRA 222 mechanisms. The generated weights are added to corresponding layers, e.g., 232, 238, etc., of the pre-trained ML model 230. The newly configured pre-trained ML model 230 generates an output that is used to determine the training loss by the training loss function 260 given input data samples for the one or more tasks, e.g., task 0 and task 1 in the depiction of FIG. 2. After the optimization phase of operation, i.e., after convergence, the Pareto-front is approximated 270. This may involve repeating the following process of first selecting a single λ vector, generating the LoRA weight via the hypernetwork 224 of the conditioning modules 220 and adding the generated weights to the layers of the pre-trained ML model 230, computing the loss function for each task and placing a point for the Pareto-front. Thus, the Pareto-front is approximated and may then be used to select additive parameters for fine tuning the pre-trained ML model 230 for particular tasks or sets of tasks given a set of input hyperparameters λ. The Pareto-front is used by inputting one or more hyperparameters λ and obtaining the additive parameters which correspond to the points of the input hyperparameters λ along the Pareto-front. This use of the Pareto-front is performed in an automated manner in some embodiments, e.g., via implementation of the software associated with the Coefficient Conditioning Module 200.

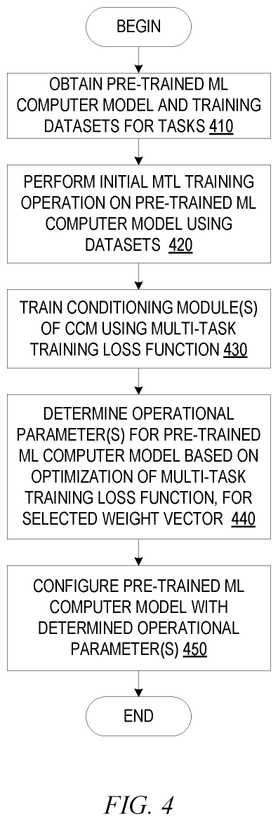

FIG. 4 presents a flowchart outlining example operations of elements of the present invention with regard to one or more illustrative embodiments. It should be appreciated that the operations outlined in FIG. 4 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 4, and may, in some cases, make use of the results generated as a consequence of the operations set forth in FIG. 4, the operations in FIG. 4 themselves are specifically performed by the improved computing tool in an automated manner.

As shown in FIG. 4, the operation starts by obtaining a pre-trained machine learning computer model, e.g., neural network, that is pre-trained for a particular task and training datasets for the various tasks of the MTL operation (step 410). This pre-trained machine learning computer model may be, for example, in some cases, a foundation model, large language model, or the like, which may have been trained for generalized use rather than any specific task.

As part of a multi-task learning (MTL) operation on this pre-trained machine learning computer model, an initial MTL training of the pre-trained machine learning computer model is performed on training data samples for each of the multiple tasks to generate an initial set of weights (step 420). This initial pre-training in step 420 is performed via a first set of multi-task training data which may be different than or the same as other multi-task training data that is used subsequently in steps 430, 440, and/or 450. In some embodiments step 420 is skipped and a pre-trained ML model is instead obtained, retrieved, downloaded, and/or accessed whose initial set of weights is already known, so no multi-task pre-training in step 420 is needed. Step 430 aims to train weights θ {0, . . . } because step 430 does not update θ.

Given the initial set of weights, a conditioning module of the CCM is trained using a weighted multi-task training loss function of the illustrative embodiments, which combines the weighted loss functions for the individual tasks of the pre-trained machine learning computer model (step 430). Weight vectors (e.g., lambda λ vectors) are sampled, e.g., selected, in some embodiments from a uniform distribution for use in step 430. In various embodiments the uniform distribution is continuous, e.g., symmetrical, or discrete. If a user specified that the lambda λ vector is either [0.1, 0.9] or [0.9, 0.1] one is selected uniformly, e.g., with a probability like a coin flip. This training optimizes the weighted multi-task training loss function of the conditioning module, where the weights are the relative priorities of the corresponding task. As described in equation (3) above which implemented an example of computing a weight average of each loss function value, each of the various task's loss function is evaluated before they are combined. Each loss function is calculated by using a corresponding training data set (e.g., corresponding to the specific task of the multiple tasks) and a corresponding element of each sampled weight vector. The corresponding element refers to the lambda λ vector's element that represents the relative importance of a task t. After evaluating each loss value and taking a lambda λ vector, then the weight average of each loss function value is computed. Step 430 trains the conditioning module's parameter ϕ to avoid updating all parameters including the pre-training ML model's parameters θ. Step 430 is depicted in FIG. 2 (except for the approximating Pareto-front 270) and includes operation of both the conditioning module 220 and the pre-trained ML model 230.

Thereafter, the operational parameters for the pre-trained machine learning computer model are simulated given a weight vector for the pre-trained machine learning computer model, such as the weight values determined from the initial MTL training operation (step 440). The trained conditioning module (trained in step 430) is used to perform this step 440. After the training of step 430, step 440 includes receiving a specific lambda λ vector and then running the trained conditioning module 220 by inputting the received specific lambda λ vector into the trained conditioning module 220 and, in response, as output receiving conditioning parameters for θ for the pre-trained ML model 230. Then the original θ from the pre-trained ML model 230 are replaced with the conditioning θ obtained from the conditioning module 220 (as in Equation (1)'s right hand side). Then for step 440, multi-task learning losses are generated with the modified/updated pre-trained ML model 230.

The pre-trained machine learning computer model is then configured with the determined operational parameters (step 450). The operation then terminates.

To obtain multiple points to draw a Pareto-front, the present embodiments use conditioning module to condition θ by the λ vector, and θ changes depending on the λ vector that is input. By using this trained conditioning module, the pre-trained ML model 230 behaves differently depending on the λ vector that is input. As a result, multiple points are obtained to draw an approximated Pareto-front by changing the lambda λ vectors. Thus, the present embodiments overcome challenges of using the naïve approach to generate a Pareto-front.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
sampling weight vectors from a pre-defined distribution to produce sampled weight vectors;
training a conditioning module by minimizing a multi-task training loss over the sampled weight vectors, the multi-task training loss being a combination of task loss functions resulting from multiple tasks, respectively, each of the task loss functions being calculated by using a corresponding training data set and a corresponding element of the respective sampled weight vector, wherein the conditioning module comprises computer executable logic implementing a function from the sampled weight vectors to a parameter space of a pre-trained machine learning model, the elements of the weight vector specifying a relative importance of a corresponding task of the multiple tasks;
determining an operational parameter for the pre-trained machine learning model by using the trained conditioning module; and
reconfiguring the pre-trained machine learning model with the determined operational parameter.

2. The method of claim 1, wherein the reconfiguring comprises adding the determined operational parameter to a layer of the pre-trained machine learning model.

3. The method of claim 1, wherein the conditioning module implements a product of low-rank matrices according to a Low-Rank Adaptation (LoRA) technique.

4. The method of claim 1, wherein the determining the operational parameter and the reconfiguring the pre-trained machine learning model are performed iteratively over varied selected weight vectors to produce respective graph points; and
wherein the respective graph points are added to a graph to produce an approximated Pareto-front.

5. The method of claim 4, further comprising inputting a hyperparameter to the approximated Pareto-front to receive a corresponding additive parameter for fine-tuning the pre-trained machine learning model.

6. The method of claim 1, wherein the pre-defined distribution from which the weight vectors are sampled is a uniform distribution of weight vectors.

7. The method of claim 1, wherein the conditioning module comprises a second machine learning model that is smaller than the pre-trained machine learning model.

8. The method of claim 7, wherein the second machine learning model comprises a hypernetwork.

9. The method of claim 1, wherein the method is performed for multiple conditioning modules, wherein each reconfiguring is performed via adding the determined operational parameters to a respective different layer of the pre-trained machine learning model.

10. The method of claim 1, further comprising performing initial multi-task pre-training on the pre-trained machine learning model so that an initial set of weights is produced;
wherein the initial set of weights is provided for the training of the conditioning module.

11. The method of claim 10, wherein an approximated Pareto-front is produced and the performing the initial multi-task pre-training occurs only once.

12. The method of claim 1, wherein the pre-trained machine learning model is one of a foundation model or a large language model that is pre-trained on first sets of data, and wherein the reconfiguring prepares the pre-trained machine learning model for a specific task or set of specific tasks.

13. A computer program product comprising:
a set of one or more computer-readable storage media; and
program instructions, collectively stored in the set of the one or more computer-readable storage media, for causing a processor set to perform computer operations comprising:
sampling weight vectors from a pre-defined distribution to produce sampled weight vectors;
training a conditioning module by minimizing a multi-task training loss over the sampled weight vectors, the multi-task training loss being a combination of task loss functions resulting from multiple tasks, respectively, each of the task loss functions being calculated by using a corresponding training data set and a corresponding element of the respective sampled weight vector, wherein the conditioning module comprises computer executable logic implementing a function from the sampled weight vectors to a parameter space of a pre-trained machine learning model, the elements of the weight vector specifying a relative importance of a corresponding task of the multiple tasks;
determining an operational parameter for the pre-trained machine learning model by using the trained conditioning module; and
reconfiguring the pre-trained machine learning model with the determined operational parameter.

14. The computer program product of claim 13, wherein the reconfiguring comprises adding the determined operational parameter to a layer of the pre-trained machine learning model.

15. The computer program product of claim 13, wherein the conditioning module implements a product of low-rank matrices according to a Low-Rank Adaptation (LoRA) technique.

16. The computer program product of claim 13, wherein the determining the operational parameter and the reconfiguring the pre-trained machine learning model are performed iteratively over varied selected weight vectors to produce respective graph points; and
wherein the respective graph points are added to a graph to produce an approximated Pareto-front.

17. A computer system comprising:
a processor set;
a set of one or more computer-readable storage media; and
program instructions, collectively stored in the set of the one or more computer-readable storage media, for causing a processor set to perform computer operations comprising:
sampling weight vectors from a pre-defined distribution to produce sampled weight vectors;
training a conditioning module by minimizing a multi-task training loss over the sampled weight vectors, the multi-task training loss being a combination of task loss functions resulting from multiple tasks, respectively, each of the task loss functions being calculated by using a corresponding training data set and a corresponding element of the respective sampled weight vector, wherein the conditioning module comprises computer executable logic implementing a function from the sampled weight vectors to a parameter space of a pre-trained machine learning model, the elements of the weight vector specifying a relative importance of a corresponding task of the multiple tasks;
determining an operational parameter for the pre-trained machine learning model by using the trained conditioning module; and
reconfiguring the pre-trained machine learning model with the determined operational parameter.

18. The computer system of claim 17, wherein the pre-defined distribution from which the weight vectors are sampled is a uniform distribution of weight vectors.

19. The computer system of claim 17, wherein the conditioning module comprises a second machine learning model that is smaller than the pre-trained machine learning model.

20. The computer system of claim 19, wherein the second machine learning model comprises a hypernetwork.
